(19) United States
(12) Patent Application Publication
(10) Pub. No.: US 2019/0124742 A1
(43) Pub. Date: Apr. 25, 2019

(54) LIGHTING CONTROL SYSTEM AND METHOD OF USE

(71) Applicant: James O'Carroll, Cave Creek, AZ (US)

(72) Inventor: James O'Carroll, Cave Creek, AZ (US)

(21) Appl. No.: 16/163,062

(22) Filed: Oct. 17, 2018

Related U.S. Application Data
(60) Provisional application No. 62/576,220, filed on Oct. 24, 2017.

(51) Int. Cl. H05B 33/08; F21S 9/02; F21S 9/04

(52) U.S. Cl. CPC H05B 33/0854; H05B 33/0821; F21S 9/043; F21S 9/024; H05B 33/0866

(57) ABSTRACT

A lighting fixture control with microprocessors, a transceiver and an expansion connector port system for modular incorporation of components to add functions, capabilities, connectivity and control to an LED light fixture and/or a network of multiple light fixtures; a controller hub coupled to the light fixture, having energy storage modules to provide a power source for emergency backup and/or load shed capability to the light fixture. The controller hub provides for modular incorporation of the one or more accessories and sensors to control light intensity, light brightness, and color of the light fixture.

### BACKGROUND

### 1. Field of the Invention

The present invention relates generally to lighting systems, and more specifically, to a lighting control system that incorporates a modular style architecture of a controller hub to provide the user with a plurality of accessories to add new functionalities, capabilities and user control of one or more lighting fixtures. The system of the present invention includes a printed circuit board (PCB) encased in a housing/module. The PCB is populated with microprocessor(s), memory, wireless transceiver and accessory connector port(s) to attach external electronic accessories such as sensors, cameras, microphones and/or energy storage modules (battery packs) to add both individual and collective control, network connectivity, and other functions/enhancements to any standard LED luminaire.

### 2. Description of Related Art

Lighting control systems are well known in the art and are effective means to control one or more lights. For example, there are products that include intelligent lighting control utilizing microprocessors and power electronics. These controllers can perform operations such as variable lighting intensities, occupancy sensors, power usage metering, and connectivity.

One of the problems commonly associated with conventional lighting systems is limited use. For example, there currently is not a product or system that provides for a modular style architecture which can combine a plurality of accessories into a control system which thereby provides for a lighting solution that is greater than the sum of its parts.

The system of the present invention provides for the above solution, as will be described and disclosed herein.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a lighting control system in accordance with an embodiment of the present application;

FIG. 2 is a simplified schematic of key systems within a controller hub of FIG. 1;

FIG. 3 is a simplified schematic of some of the additional accessories that can connect to the controller hub of FIG. 1;

FIG. 4 is an oblique view of an embodiment of the controller PCB and hub housing; and

FIG. 5 is an oblique view of an embodiment of the energy storage module (battery pack) that has been designed to connect to the control hub to provide emergency backup and/or load shedding power to the LED light fixture. It comprises of one or more rechargeable batteries in an enclosure with electrical contacts and wires terminated with a plug-in style connector.

While the system and method of use of the present application is receptive to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will, of course, be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use, in accordance with the present application, overcomes one or more of the above-discussed problems commonly associated with conventional lighting control systems. Specifically, the present invention provides for a controller hub, which can be retrofitted into existing, previously installed luminaires, or built into newly manufactured lighting devices to provides a modular architecture to incorporate one or more accessories/technologies to customize control of the lighting device and add new capabilities and functionalities. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

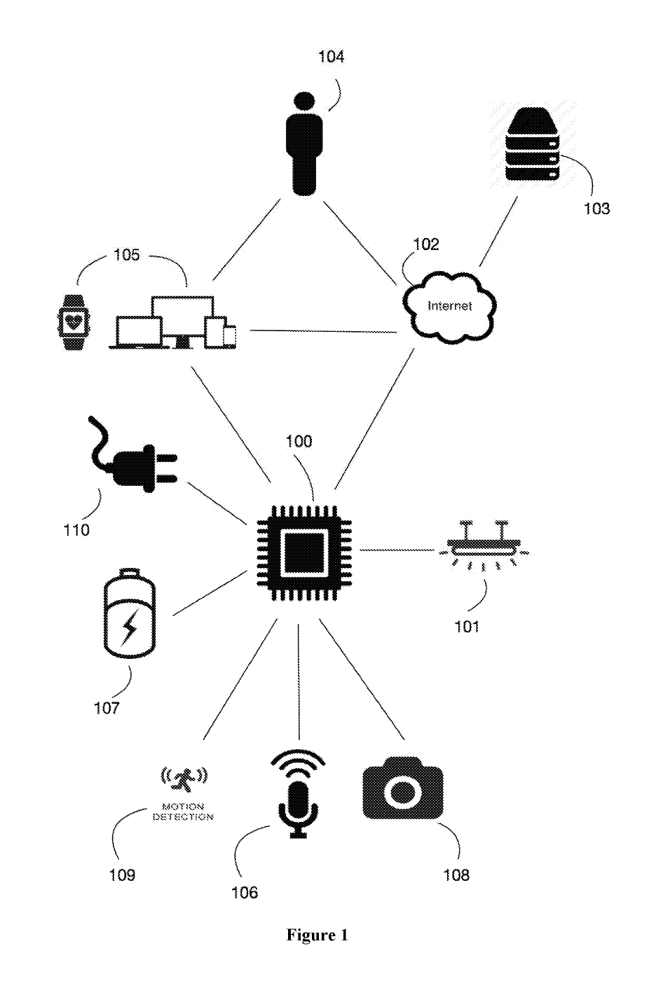

Referring to the drawings wherein like reference characters identify corresponding or similar elements throughout the several views, FIG. 1 depicts a simplified schematic of some of the enhancements that are available to a lighting system with the controller hub 100 in accordance with a first embodiment of the present application. It will be appreciated that this new system overcomes one or more of the above-listed problems commonly associated with conventional lighting control systems.

In the contemplated embodiment, the system includes a controller hub 100 coupled to a light fixture 101 and with a plurality of accessories 106, 108, 109. The type of light fixture 101 is irrelevant and can be a new installation or existing installation. In this embodiment, a power source 110 provides the main power to at least the controller and the light fixture 101.

In one embodiment, an energy storage device 107 is coupled with the controller hub 100 to be an emergency battery backup that will power the light fixture in the event of a loss of power from the primary AC source 110. In this embodiment, the controller hub 100 can be configured to perform a power loss test by “disconnecting” the primary power 110 via the controller hub 100 and forcing the light fixture 101 to use the energy storage device 107 as the needed power source.

In one embodiment, the energy storage device 107 can be configured to act as both an emergency backup battery and also in a load shedding mode to power the light fixture to reduce power grid energy usage during peak demand periods.

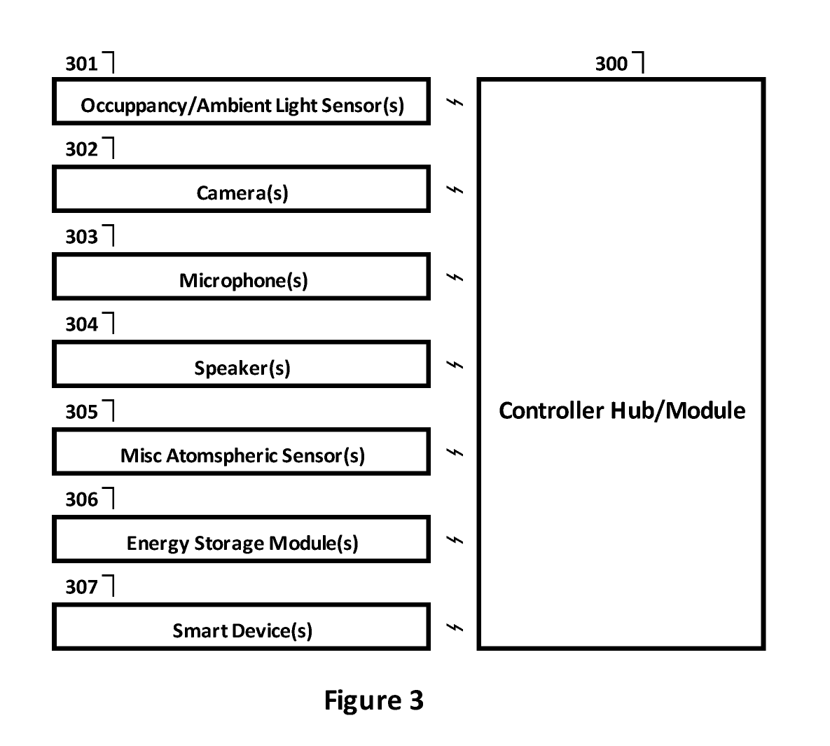

It should be appreciated and understood that the accessories shown in FIG. 1 are merely exemplary of the types of accessories which can be incorporated into the present application, but does not include all the possible equipment that can be added to the control hub, additional accessories will be discussed in connection with FIG. 3.

The system can include the connection of a motion detection sensor 109 to the controller, wherein the detection of a motion (such as when a person enters the room) can activate a command to the controller hub. The command can be to activate lighting allowing specific settings of the brightness or on/off state of the light fixture(s) 101.

An additional accessory shown in FIG. 1, is a microphone 106, which can be coupled to the controller hub 100 to enable specific settings of the brightness or on/off state of the light fixture(s) 101 based on the detection of sound or sound patterns.

In the preferred embodiment, the controller hub 100 can further be coupled to a smart device 105. This coupling can be achieved through the wireless Bluetooth or Zigbee Wi-Fi transceiver onboard the controller hub 100 to send and receive commands via application software on smart devices 105 and/or either of these devices via a connected network 102.

Additionally, a microphone 106 can receive sound data which can be transmitted via the wireless transceiver on the controller hub 100 to connected smart devices 105.

An additional accessory shown herein, is a camera 108, which can be coupled with the controller hub 100 to provide a means to allow specific settings of the brightness or on/off state of the light fixture(s) 101 based on the video patterns being read from the camera.

Additionally, the video data from the camera 108 can be transmitted via the wireless transceiver on the control hub 100 to connected smart devices 105 to be viewed in real time.

In one embodiment, a user 104 may configure the controller hub 100 using an application on a smart device 105 at the time of installation, and/or update or re-configure during maintenance, or during general usage.

A server 103 can further be configured to receive and collect data from the controller hub 100 and the like.

It should be appreciated that one of the unique features believed characteristic of the present application is the modular architecture of the controller hub, which is configured to allow for use with a plurality of accessories to control one or more lighting fixtures with multiple functions and capabilities that would not otherwise be possible nor available.

Additionally, it should be appreciated that a combination of circuitry and software connecting and commanding the microprocessor(s), memory, transceiver and connector ports on the control hub enable a plurality of control devices, practical applications, capabilities and functionalities not previously available.

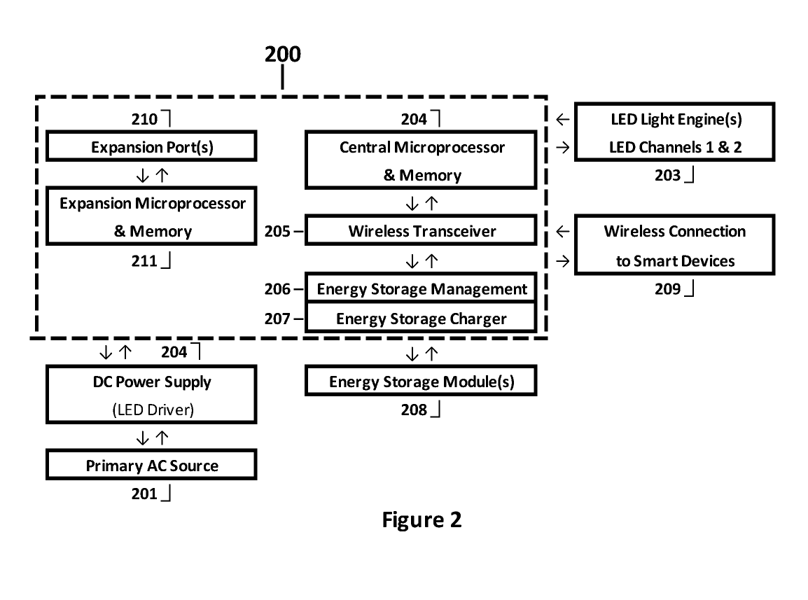

FIG. 2 shows a schematic of an embodiment of a controller hub 200 connected to the LED light engine(s) within the luminaire 203. It should be appreciated that the controller hub 200 can be attached to the luminaire's DC power supply (LED driver) 204, which is powered by the primary AC source 201 or alternatively the controller hub can have its own DC power supply onboard the PCB and is connected directly to the primary AC source 201. The controller hub has a central microprocessor with nonvolatile memory 204 which contains the program code, configuration, and operational data. In this embodiment, the controller hub 200 can auto-detect loss of power and automatically power the LED light engines within the luminaire for a minimum of 90 minutes at an illumination level within commercial/industrial building code requirements via the energy storage module 208.

FIG. 2 shows the expansion port(s) 210, which represent the ability to couple accessories to the controller hub 200 customizing its functionality. These include, but not limited to, occupancy sensor(s), cooling equipment, microphone(s), speaker(s), temperature sensor(s), humidity sensor(s), ambient light level detection sensor(s), and camera(s).

In one embodiment, the wireless transceiver 205 is utilized to be coupled with smart devices and the internet to provide for wireless communication between the attached sensors and/or accessories and each connected light fixture.

In one embodiment, the energy storage module 208, an attachable battery pack device, is charged, managed and protected by the controller hub's 200 onboard energy storage charger 207 and energy storage management system 206, which monitors the charging, discharging, and safety status of the energy storage module 208.

In one embodiment, the energy storage module 208 battery status data is transmitted by the controller hub 200 to devices coupled through its wireless transceiver 205.

In one embodiment, controller hub 200 is configured with both the central microprocessor and memory 204, and a separate and independent expansion microprocessor and memory 211, which is dedicated to the expansion port(s) 210. In this embodiment, the software on the second microprocessor, being independent and separate from the primary functionality, can be presented as open source software to the community enabling a variety of integrations and expansions by third parties.

In FIG. 3, a simplified schematic depicts the accessories and elements discussed above, namely the coupling of a controller hub 300 to one or more of an occupancy/ambient light sensor 301, a microphone 303, a speaker 304, a temperature sensor 305, and a camera 302. It should be appreciated that the controller is configured to be used with some or all, thereby providing for the control of the lighting fixture based on any data received, such as the entry of a person into a room, the limited light within a room, voice commands, or the like.

Further, as shown, the controller hub 300 can be used with an attachable energy storage module 208 as an emergency lighting device which automatically activates in the event of a loss of power.

The controller hub 300 further can communicate with smart device(s) 307 as previously discussed. The smart devices can provide a means for controlling luminaire(s) containing a controller hub 300 through a mobile application or the like, the control including one or more of: dimming schedules, dimming levels, load shedding schedules, time-stamped energy storage module charge status reports. In addition to configuration, analytics and data feedback from the controller hub 300, such items can be received and viewed through the web or smart device application. This may include, but not limited to, the following: energy storage voltage and charge levels; energy storage usage and charging status; presented in a variety of durations and levels.

In one embodiment the energy storage module 306 can be connected and configured in a load shed mode. This is a unique and important feature in the market where the controller hub 300 can then disconnect the luminaire(s), from the primary electrical supply to reduce the electrical costs and the level of the building's carbon footprint. In one embodiment, this load shedding can be configured based on a daily schedule. In one embodiment, this schedule can be manually programmed through an application or interface to begin powering the luminaire(s) via the energy storage module(s) at specific start and stop intervals. When coupled with a smart device or the internet, the schedule can be programmed by an application on the smart device or a web page on the internet.

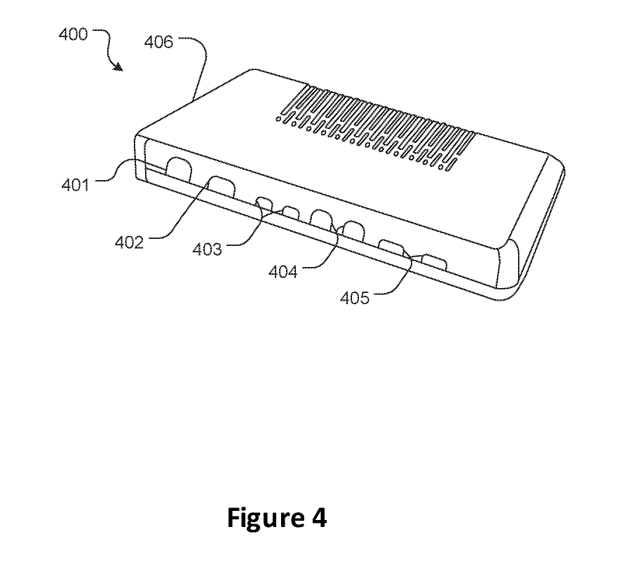

In FIG. 4, a first embodiment of a controller hub 400 is shown within an enclosure case 406 and configured to plug into any LED luminaire from 5 to 50 watts. This device provides a constant current that can be incrementally set within a range from 250 to 1050 mA, up to a max of 48 VDC. It can further include two LED channels, each dimmable from 1-99%. This device includes a plurality of ports 401, 402, 403, 404, 405 configured to receive accessories described herein. Further, this controller is configured to be added to any LED light fixture to offer the options discussed herein.

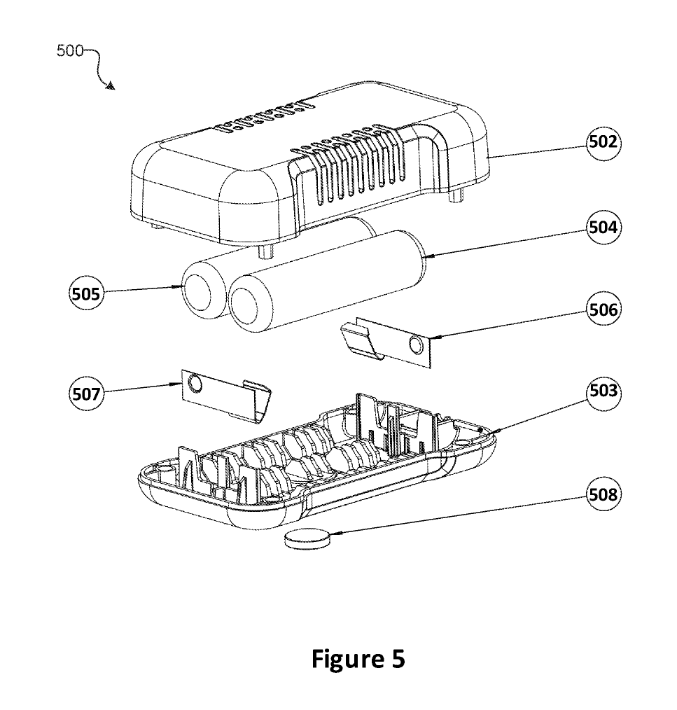

In FIG. 5, the energy storage module 500 is shown, which is configured to be attached to the controller hub 300 discussed herein, and can provide emergency power in the event of a power outage and/or deployed for up to six hours per day during peak periods to lower utility demand charges. The energy storage module 500 can include an enclosure case, with a top 502 and bottom 503 with a plurality of wires (not shown) for implementing the connection to the controller hub 300 through a plug-in style connector. This energy storage module 500, includes batteries 504, 505 and battery contacts 506, 507, and can further include one or more magnets 508.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A lighting fixture control system for control based on a modular incorporation of components, the system comprising:
a light fixture;
a controller hub connected to a DC Power Supply connected to an incoming main AC power, and the controller hub coupled to an LED light engine(s) within the light fixture; and
one or more accessories connected to the controller hub and configured to provide data to the controller hub to command the light fixture;
wherein the controller hub provides for modular incorporation of the one or more accessories to control the light fixture; and
wherein the controller hub is configured to control light intensity, light brightness, and color of the light fixture.

2. The system of claim 1, further comprising:
an energy storage module attached to the controller hub and configured by the controller hub to power the light fixture and controller hub.

3. The system of claim 2, wherein the energy storage module is a backup battery and is configured for use in an event of a temporary loss of power to the light fixture from the main AC power source.

4. The system of claim 2, wherein the energy storage module is configured to provide power to the light fixture for a predetermined amount of time each day in lieu of the main AC power source as a mechanism to reduce electrical energy costs.

5. The system of claim 1, wherein the one or more accessories comprises:
a motion detector;
a microphone; and
a camera;
wherein the controller hub is configured to adjust the lighting fixture based on detecting motion, detecting a predetermined sound pattern; and detecting a video pattern.

6. The system of claim 1, further comprising:
a wireless network; and
a smart device configured to wirelessly communicate with the controller hub via the wireless network;
wherein the computing device is configured to send commands to the controller hub and collect data from the controller hub.

7. The system of claim 1, wherein the controller hub further comprises:
a power management system configured to control power output by the lighting fixture and the controller hub.

8. The system of claim 7, wherein the power management system is configured to turn off incoming power forcing the controller hub to utilize an energy storage module for power;
wherein the power management system is configured to monitor incoming power for statistics and data collection.

9. The system of claim 1, wherein the one or more accessories comprises:
an occupancy sensor;
a cooling equipment;
a microphone;
a speaker;
a temperature sensor;
a humidity sensor;
a light level detection sensor; and
a camera;
wherein the controller hub is configured to command the lighting fixture based on data received from one or more of the one or more accessories.

10. The system of claim 1, wherein the controller hub further comprises:
a plurality of ports configured to receive one or more connector wires associated with the one or more accessories.

11. The system of claim 1, wherein the controller hub further comprises:
a transceiver configured to wirelessly communicate with the one or more accessories.

12. The system of claim 1, wherein the light fixture is an LED light fixture.

13. The system of claim 1, wherein the DC power supply is incorporated directly into the controller hub, thereby allowing for the controller hub to connect directly to the AC power.
